(19) United States
(12) Patent Application Publication
(10) Pub. No.: US 2012/0011498 A1
(43) Pub. Date: Jan. 12, 2012

(54) METHOD, DEVICE AND COMPUTER PROGRAM PRODUCT FOR AUTOMATIC PROVISIONING OF CONTENT AT THE DEVICE

(75) Inventors: Maheswari Govindaraju, Tamilnadu (IN); Arun Ephrem Sunny, (US); Raghu Ram, Bangalore (IN)

(73) Assignee: NOKIA CORPORATION, Espoo (FI)

(21) Appl. No.: 12/981,608

(22) Filed: Dec. 30, 2010

(30) Foreign Application Priority Data
Dec. 31, 2009 (IN) 3247/CHE/2009

(51) Int. Cl. G06F 9/445

(52) U.S. Cl. 717/178

(57) ABSTRACT

Method, device and computer program product for automatic provisioning of content are provided. The method includes receiving a content to be processed at a device. The method further includes automatically determining, by an application dependency manager, files required for processing the content at the device. Furthermore, the method includes downloading the files required for processing the content from a source external to the device. Thereafter, the method includes processing the content at the device using the files.

### CROSS REFERENCE TO RELATED APPLICATIONS

This application claims priority to Indian Application No. 3247/CHE/2009 filed Dec. 31, 2009, which is incorporated herein by reference in its entirety.

### TECHNICAL FIELD

The present disclosure generally relates to deployment of content at devices, and more particularly, to automatic provisioning of the content at a device.

### BACKGROUND

Presently, devices such as mobile phones have capabilities of handling software based applications and documents of various file types. People generally download content such as application packages, new software applications, documents, and the like, at their mobile phones. Further, mobile phone users also upgrade existing content on their mobile phones by installing the latest updates and releases of the content as offered by developers of the content.

To process a particular content at a device, a variety of applications (also referred to as dependencies) may be required to be present at the device. The content may require the dependencies such as runtime applications, libraries or application installations packages to be present at the device, so the content may be installed and/or accessed at the device. For example, if the user downloads content such as an application package, the installation of the application package may require a suitable installer and runtime applications. The application package may not be installed at the device due to unavailability of the suitable installer and the runtime applications. Similarly, a document downloaded at the device, may not be recognized by the device if the device does not have any suitable application to access a file type of the document. For example, if the user downloads a video file in a new format, the user may not be able to play the video file as a suitable application to play the video file is not present at the device.

Developers generally address the above problem by manually preparing a single package containing the content along with the dependencies of the content, so that the content may be processed at the device without requiring any additional file. The single package of the content may be installed into the device. For example, device such as mobile phone may require installing any particular application development framework. Accordingly, the developers of the framework may be required to provide entire runtime applications as part of installation package of the application development framework. Such inclusion of the entire runtime applications not only increases the installation package, but also increases the installation time and introduces various other complexities like upgrading already present libraries at the mobile phone.

However, there are existing techniques which provide solutions with which a developer can create an environment for installation of the dependencies of the content. The developers introduce a dependency manager at the device. The dependency manager may be introduced as part of content such as an application package that is downloaded at a device. The dependency manager checks for the dependencies mentioned within a configuration file of the application package. It may be very difficult to resolve the multi-level dependencies of the content in these techniques, unless the entire dependencies of the content are mentioned in the configuration file. The multi-level dependencies herein represent the entire dependencies of the content at different levels. For example, the installation of the application package may require a first installer to be present at the device; however, a particular library file may also be required for installing the first installer. Hence, the multi-level dependency for the content may include the first installer and the library file. Accordingly, the developer needs to mention the entire dependencies of the application package within the configuration file that is provided along with the application package.

Further, such techniques may have strict requirement that the dependency manager should be bundled with each application package that will be installed at the device. However, in some cases, the dependency manager may also be present at the device. In such cases, different application packages are required for a device which has the dependency manager and a device which does not have the dependency manager. Further, these techniques do not provide any mechanism to update the dependency manager already present on the device, which may limit installation capabilities of the dependency manager.

Based on the foregoing, there is a need for automatically provisioning of content at a device, and precluding any requirement of providing dependencies with the content in order to process the content at the device. Further, there is a need to resolve the multi-level dependencies of the content.

### SUMMARY

General purpose of various embodiments is to describe a method, a device and a computer program product for automatically provisioning content at the device.

In one aspect, a method for automatically provisioning content at a device is provided. The method includes receiving a content to be processed at a device. Further, the method includes automatically determining, by an application dependency manager, files required for processing the content at the device. The method further includes downloading the files required for processing the content from a source external to the device. Thereafter, the method includes processing the content at the device using the files.

In an embodiment, the method includes checking presence of the files required for processing at the source external to the device for automatically determining the files, by the application dependency manager. Further, in an embodiment, the method includes checking whether the application dependency manager is available at the device upon receiving the content. The application dependency manager is configured to download the files required for processing the content from the source. Further, the method includes downloading the application dependency manager at the device if the application dependency manager is unavailable at the device. In an embodiment, the latest version of the application dependency manager is downloaded. In another embodiment, if an application dependency manager already present at the device is not the latest version, the method includes downloading the latest version of the application dependency manager at the device. In an embodiment, the application dependency manager is downloaded by a bootstrap application present in the content.

In an embodiment, the content may be an application package. The files required for processing the application package may include dependencies such as of installers, run time applications, toolkits, libraries and frameworks, required for installing the application package at the device. In another embodiment, the content may be a document. The files required for processing the document may include an application package for accessing the document. In an embodiment, the method downloads the file required for processing the document by determining a set of application packages for accessing the document, where the set of application packages may be present at the source external to the device. Further, the method performs providing an option of selecting the application package from the set of application packages. The method further provisions the application package at the device from the source based on the selection. Further, in an embodiment, the method includes installing the application package at the device, and accessing the document at the device using the application package. In yet another embodiment, the content may be a data specific to a context. In an embodiment, the data specific to the context may be received from a component of the device such as a context framework.

In another aspect, a device is provided. The device includes at least one processor and at least one memory. The at least one memory may be configured to store computer program code, the at least one memory and the computer program code configured to, with the at least one processor, cause the device at least to perform: receive a content to be processed at a device; automatically determine files required for processing the content at the device; download the files required for processing the content from a source external to the device; and process the content at the device using the files.

In an embodiment, the at least one memory may be configured to store the content and the files required for processing the content. In an embodiment, the at least one memory and the computer program code is configured to, with the at least one processor, cause the device to automatically determine the files required for processing the content by checking presence of the files at the source external to the device. Further, in an embodiment, the at least one memory and the computer program code is configured to, with the at least one processor, cause the device to check whether the application dependency manager is available at the device upon receiving the content. The at least one memory and the computer program code is configured to, with the at least one processor, cause the device to utilize the application dependency manager to download the files required for processing the content from the source. The at least one memory and the computer program code is configured to, with the at least one processor, cause the device to download the application dependency manager at the device if the application dependency manager is unavailable at the device. In an embodiment, the latest version of the application dependency manager is downloaded. In another embodiment, if an application dependency manager present at the device is not the latest version of the application dependency manager, the latest version of the application dependency manager is downloaded at the device. In an embodiment, the application dependency manager is downloaded by a bootstrap application present in the content.

In an embodiment, the content may be an application package. The files required for processing the application package may include dependencies such as of installers, run time applications, toolkits, libraries and frameworks, required for installing the application package at the device. In another embodiment, the content may be a document. The files required for processing the document may include an application package for accessing the document. In an embodiment, the processor is configured to download the files required for processing the document by determining a set of application packages for accessing the document, where the set of application packages may be present at the source external to the device. Further, the at least one memory and the computer program code is configured to, with the at least one processor, cause the device to provide an option of selecting the application package from the set of application packages, and provision the application package at the device from the source based on the selection. Further, in an embodiment, the at least one memory and the computer program code is configured to, with the at least one processor, cause the device to install the application package at the device, and access the document at the device using the application package. In yet another embodiment, the content may be a data specific to a context. In an embodiment, the data specific to the context may be received from a component of the device such as a context framework.

In yet another aspect, a computer program product comprising at least one computer-readable storage medium is provided. The computer-readable storage medium includes a set of instructions configured to cause a device at least to: receive a content to be processed at the device; automatically determine, by an application dependency manager, files required for processing the content at the device; download the files required for processing the content from a source external to the device; and process the content at the device using the files.

In an embodiment, the set of instruction are further configured to cause the device at least to check presence of the files at the source external to the device for automatically determining the files, by the application dependency manager. Further, in an embodiment, the set of instructions are configured to cause the device at least to check whether the application dependency manager is available at the device. The application dependency manager may be configured to download the files required for processing the content from the source. The set of instructions are further configured to cause the device at least to download the application dependency manager at the device if the application dependency manager is unavailable at the device. In an embodiment, the latest version of the application dependency manager is downloaded. In another embodiment, the set of instructions are further configured to cause the device at least to download the latest version of the application dependency manager at the device, if the application dependency manager present at the device is not the latest version. In an embodiment, the application dependency manager is downloaded by a bootstrap application present in the content.

In an embodiment, the content may be an application package. The files required for processing the application package may include dependencies such as of installers, run time applications, toolkits, libraries and frameworks, required for installing the application package at the device. In another embodiment, the content may be a document. The files required for processing the document may include an application package for accessing the document. In an embodiment, the set of instructions are further configured to cause the device at least to determine a set of application packages for accessing the document, where the set of application packages may be present at the source external to the device. Further, the set of instruction are configured to cause the device at least to provide an option of selecting the application package from the set of application packages, and provision the application package at the device from the source based on the selection. Further, in an embodiment, the set of instructions are configured to cause the device at least to install the application package at the device, and access the document at the device using the application package. In yet another embodiment, the content may be a data specific to a context. In an embodiment, the data specific to the context may be received from a component of the device such as a context framework.

### BRIEF DESCRIPTION OF THE DRAWINGS

The above-mentioned and other features and advantages of various embodiments, and the manner of attaining them, will become more apparent and various embodiments will be better understood by reference to the following description taken in conjunction with the accompanying drawings, wherein:

FIG. 1 is a flow chart illustrating a method for automatically provisioning of content at a device, in accordance with an embodiment;

FIG. 2 is a block diagram of a device, in accordance with an embodiment; and

FIG. 3 is a schematic block diagram illustrating automatic provisioning of content at a device, in accordance with an embodiment.

### DETAILED DESCRIPTION

Before describing in detail embodiments that are in accordance with the present disclosure, it should be observed that the embodiments reside primarily in combinations of method steps and device components related to automatic provisioning of content.

In this document, the terms “comprises,” “comprising,” or any other variation thereof, are intended to cover a non-exclusive inclusion, such that a process, method, article, device or apparatus that comprises a list of elements does not include only those elements but may include other elements not expressly listed or inherent to such process, method, article, device, or apparatus. An element proceeded by “comprises . . . a” does not, without more constraints, preclude the existence of additional identical elements in the process, method, article, device or apparatus that comprises the element.

Any embodiment described herein is not necessarily to be construed as preferred or advantageous over other embodiments. All of the embodiments described in this detailed description are illustrative, and provided to enable persons skilled in the art to make or use the disclosure and not to limit the scope of the disclosure, which is defined by the claims.

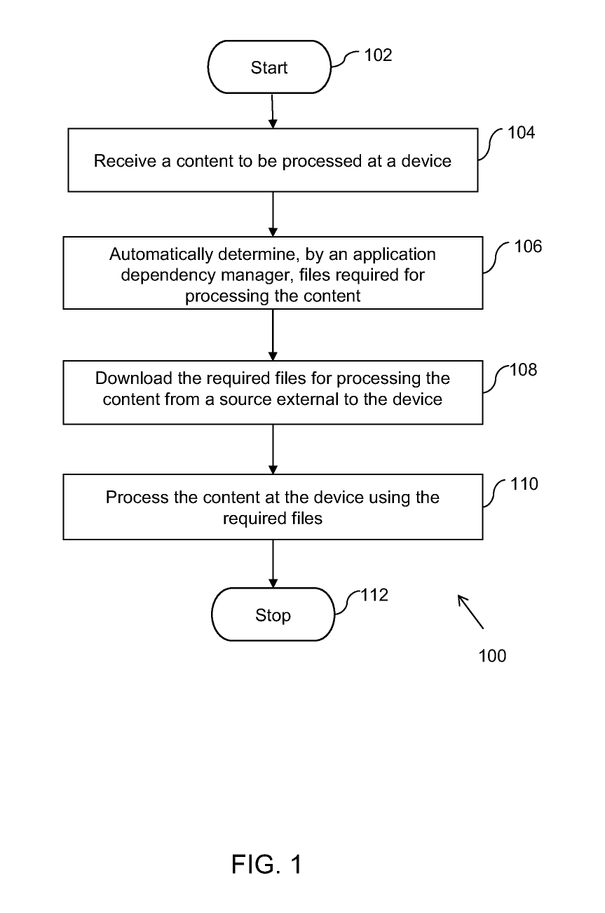

Various embodiments provide a method, a device and computer program product for automatically provisioning of content at the device. The device may be a communication device such as a mobile phone. The mobile phone may be capable of supporting communication in accordance with one or more of a first-generation (1G), second-generation (2G), 2.5G, third-generation (3G) and/or future mobile communication protocols, and the like. For example, the mobile phone may be compliant with the wireless communication protocols such as IS-136 (TDMA), GSM, IS-95 (CDMA), GPRS, Enhanced Data GSM Environment (EDGE), Universal Mobile Telephone System (UMTS), WiMAX and network employing Wideband Code Division Multiple Access (WCDMA). The mobile device may be able to support various software applications, and may be able to integrate suitable platforms such as Symbian Operating System (OS), iPhone OS, RIM's BlackBerry, Samsung bada, Windows Mobile, Palm WebOS, Android and Maemo. It should also be pointed out that the device may also include any general purpose or specific purpose computer or other electronic device, in addition to the mobile phone. The present disclosure provides solutions for provisioning content at the device automatically, which will be described in detail in conjunction with FIGS. 1-3.

Referring to FIG. 1, a flow chart of a method 100 is illustrated, in accordance with an embodiment. The method starts at 102. At 102, content is received at the device. The content is received at the device to be processed at the device. The content may be an application package to be installed at the device, a document to be accessed at the device, any data specific to a context, and the like.

In some embodiments/examples, the device may require some files to process the content at the device. For example, content such as an application package is received to be installed at the device. Further, the installation of the application package may require some dependent files (hereinafter referred to as ‘dependencies’) to be present at the device. Examples of the dependencies may include, but are not limited to, installers, runtime applications, toolkits, libraries and the frameworks at the device. In one form, the runtime applications may include native and web related runtime applications. There may be a case where any of the dependencies may not be available at the device, and accordingly, the device may require these dependencies to be present at the device in order to install the application package at the device. In another example, the content may be a document that is received at the device. The device may require an appropriate application to access the document. Accordingly, the dependency for the document may be a particular application and any other further dependency of the particular application.

Further, at 104, an application dependency manager (ADM) determines files required (dependencies) for processing the content at the device. For example, the ADM is configured to determine the dependencies for installing the application package. In an embodiment, the ADM is configured to determine the multi-level dependencies for the application package. For example, the application package may be dependent on a first installer, a toolkit and a runtime application, where the toolkit is further dependent on a second installer. Accordingly, the ADM is configured to determine a first level dependency such as the first installer, the toolkit and the runtime application, as well the second level dependency of the toolkit such as the second installer. Once all the dependencies are determined, the ADM may ensure that all the dependencies are installed.

In an embodiment, the ADM automatically determines the dependencies from a source external to the device (hereinafter referred to as ‘external source’). The external source may be any external sever, application stores, repository or database, for example, an OVI server or a Horizon server. A person skilled in the art would appreciate the fact that the ADM typically determines the dependencies of the content from the external source, automatically. In one embodiment, the external source may include some component of the ADM, which helps the ADM of the device to resolve all the dependencies of the content. In one form, such component of the ADM at the external source may include metadata package having the dependencies. In one form, the ADM automatically receives the dependencies from the metadata package of the external source, once the ADM requests for the dependencies to the external source. It should also be pointed out that the ADM will also resolve the dependencies from a configuration file if all the dependencies are mentioned in the configuration file of the application package.

At 106, the method 100 performs downloading the required files (dependencies) for processing the content from the external source. For example, the dependencies for the application package such as the first installer, the toolkit, the runtime application and the second installer are downloaded at the device. It should be pointed out that the dependencies may be downloaded at the device over GPRS, WLAN, or any other supported medium of communication in the device. The dependencies may also be installed at the device after the download is completed. In another example, dependency for the document, such as the particular application package (for example, a document reader) may be downloaded at the device. The document reader may further be installed at the device.

Further, at 108, the content is processed at the device using files corresponding to the dependencies that are downloaded and/or installed at the device. For example, the application package is installed using the first installer, the toolkit, the runtime application and the second installer. In another example, the document may be accessed using the document reader installed at the device. Thereafter the method can terminate at 110.

In an embodiment, the method 100 also performs downloading the ADM, if the ADM is not present at the device. For example, the method 100 may check whether the ADM is present at the device or not. If the ADM is not present at the device, the ADM is downloaded. In one form, the ADM is downloaded through a bootstrap application present with the content. For example, the application package to be installed at the device may include at least one application, dependency file and a bootstrap application. Receiving the application package may include installing the bootstrap application and copying the application and dependency files at the device. The bootstrap application may be utilized to download the ADM from the external source. In another form, even if the ADM is present at the device, it may be checked whether the ADM present at the device is of latest version. If the latest version of the ADM is not present at the device, the latest version of the ADM is downloaded and installed at the device.

Accordingly, the ADM automatically resolves all the dependencies of the application package and download any missing installers/runtime applications by communicating to the external source. It should also be pointed out that ADM also determines the dependencies from a configuration file, which is present within the content. Further, even if the configuration file is not present in the application package, or the configuration file does not include all the dependencies of the application package, the ADM is able to resolve the dependencies from the external server. Further, the ADM is also configured to determine the multi-level dependencies of the content.

In another embodiment, the present disclosure may also provide automatically provisioning of content such as a data specific to a context. In one form, the data may be received from a component of the device, such as a context framework. Without limiting the scope of the present embodiment, in one form, the context framework may be present at the device. Example of context framework may be calendar application context framework, task application context framework, multimedia application context framework, and the like. The context framework may identify the user's frequent usage of some applications, and accordingly may identify user's interests of particular applications and documents. Context framework may further request the ADM to install applications or download documents such as pictures, ring tones, widgets, animations, text, and the like at the device, based on the user's interest and the usage pattern. The ADM further aids the context framework in downloading and installing the above applications and the documents at the device.

The method 100 may be utilized to automatically provision content as desired from components of the device such as the context framework. The context framework typically identifies a user's interest and inherent desires/expectations from the device. Based on this, an input such as data specific to the context may be provided to the ADM. For example, content such as the data specific to context may be received from the calendar application context framework at 104. Example of the data specific to the context may be a travel plan to a city ‘X’ at a particular time. For the processing of the content (data), various information files and applications may be required, such as weather application, city guide, direction applications, widgets, music, dictionary, pictures, video, animation, and the like. These information files and applications may not be available at the device.

Further, at 106, the ADM determines the relevant information files and applications from the external source. The external server may be any designated server or repository, such as OVI store, other content providers, and the like, which keep such information files and the applications. Furthermore, at 108, the information files and the applications may be downloaded at the device. The applications may also be installed at the device and the information files may be stored at the device. Thereafter, at 110, the data specific to the context may be processed at the device using the information files and the applications.

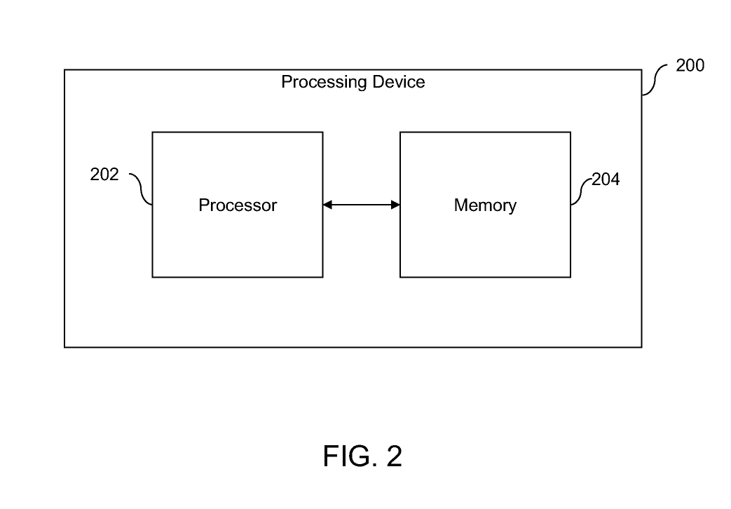

Referring now to FIG. 2, a device 200 capable of automatically provisioning content is shown, in accordance with an embodiment. In one form, the device 200 includes a processor 202 and a memory 204. However, it would be apparent to a person skilled in the art that the device 200 can include more than one procesor and more than one memory.

Examples of the processor 202 may include, but are not limited to, one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). Further, the memory 204 may be a volatile memory or a non volatile memory. Examples of the memory 204 may include, but are not limited to, a hard drive, a Read Only Memory (ROM), a Random Access Memory (RAM), Erasable Programmable Read-Only Memory (EPROM), Electrically Erasable Programmable Read-Only Memory (EEPROM), Programmable Read-Only Memory (PROM), CD-ROM, or flash memory. Preferably, the memory 204 may be permanently contained within the device 200.

The memory 204 is configured to include a computer program code. The memory 202 and the computer program code configured to, with the processor 202, cause the device 200 at least to receive content such as an application package, a document or a data specific to a context. In one form, the content may be any application package to be installed at the device 200. In other form, the content may be any document to be accessed at the device 200. In yet another form, the content may be a context data received from a context framework. As described in conjunction with FIG. 1, the device 200 may require certain files to process the content at the device 200. For example, the content such as an application package is received at the device 200 to be installed at the device 200. Further, the installation of the application package may require certain dependencies such as installers, runtime applications, a toolkit, a library and a framework to be available at the device 200. Accordingly, the device 200 may require these dependencies to install the application package at the device 200.

Further, the memory 202 and the computer program code configured to, with the processor 202, may cause the device 200 at least to determine the required files (dependencies) for processing the content at the device 200. In one form, the processor 202 may include a software/firmware application such as an application dependency manager (ADM) for determining the dependencies of the content. The ADM is configured to resolve the dependencies for installing the application package. In an embodiment, the ADM is configured to resolves the multi-level dependencies for the content such as the application package. For example, the application package is dependent on a runtime application, and the runtime application may be further dependent on an installer. Accordingly, the ADM is configured to determine a first level dependency such as the runtime application, as well the second level dependency of the runtime application such as the installer.

In an embodiment, the ADM determines the dependencies from a source external to the device 200. The external source may be any external sever, application stores, repository or database, for example, OVI server, or Horizon server. A person skilled in the art would appreciate the fact that the ADM typically determines the dependencies of the application package from the external server. In an embodiment, the external source may include some component of the ADM, which helps the ADM present at the device 200 to resolve all the dependencies related to the application package. In one form, such component of the ADM may include metadata package at the external source, where the metadata package include the dependencies. Accordingly, the ADM resolves the multi-level dependencies based on the metadata package present at the external source. It should also be pointed out that the ADM will also resolve the dependencies from a configuration file if all the dependencies are mentioned in the configuration file of the application package.

Further, the memory 202 and the computer program code configured to, with the processor 202, cause the device 200 at least to download the dependencies from a source external to the device 200. The dependencies may also be installed at the device 200 after the download is complete. The memory 202 and the computer program code may be further configured to, with the processor 202, cause the device 200 to process the content at the device 200. For example, the application package is installed at the device 200. The application package is installed using the dependencies downloaded and/or installed at the device 200.

In one embodiment, the content and the dependencies for the processing of the content may be stored in the memory 204 of the device 200. It should be understood that the memory 204 may also be a part of the processor 202.

In one embodiment, the processor 202 also performs downloading the ADM, if the ADM is not present at the device 200. For example, the processor 202 is configured to check whether the ADM is present at the device 200 or not. If the ADM is not present at the device 200, the processor 202 may download the ADM. In one form, the ADM is downloaded through a bootstrap application present within the content. For example, the application package to be installed at the device 200 may include at least one application dependency file and the bootstrap application. The processor 202 may utilize the bootstrap application to download the ADM from the external source.

In another form, even if the ADM is present at the device 200, the processor 202 may perform downloading the latest version of ADM from the external source. For example, the processor 202 may determine that whether the ADM present at the device 200 is of the latest version. If the latest version of the ADM is not present at the device, the latest version of the ADM is downloaded and installed at the device 200.

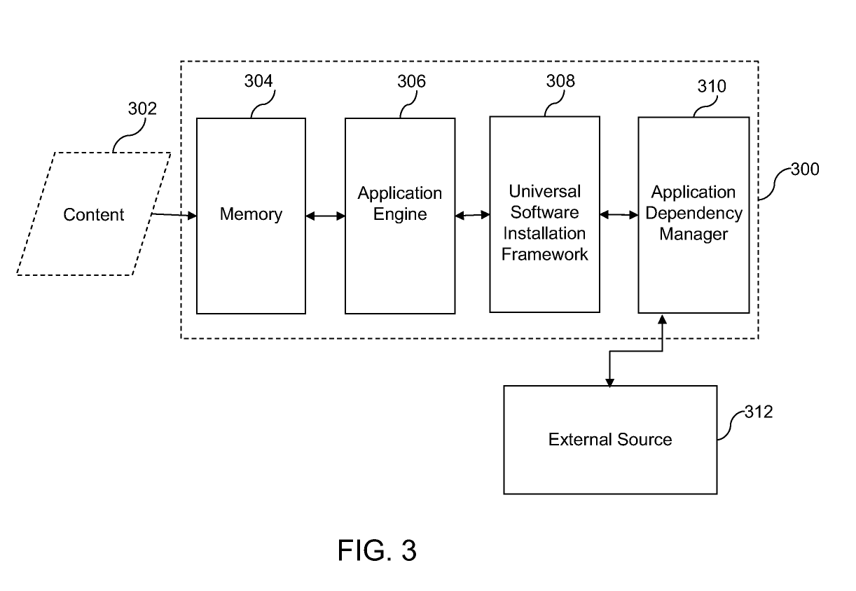

It should be pointed out from the method 100 and the device 200 that the present disclosure utilizes the ADM to determine the dependencies of any content that is to be processed at the device 200. In an embodiment, the present disclosure integrates the ADM within the device 200, which automatically resolves multi-level dependencies from the external source. The functionalities of the method 100 and the device 200 may further be understood with the help of examples, as described in conjunction with FIG. 3. FIG. 3 is a schematic block diagram illustrating automatic provisioning of the content at a device 300, in accordance with an embodiment.

As depicted in FIG. 3, content 302 is received at the device 300. In an example, the content 302 may be an application package such as a ‘mypkg.jarx’. The content 302 (mypkg.jarx application) may be an installable package. In one form, the content 302 may be downloaded to a memory 304 of the device 300. The memory 304 may be a memory module similar to the memory 204 as described in conjunction with FIG. 2.

Typically, the device 300 includes an application engine 306 that installs and processes the various applications at the device 300. The application engine 304 determines that the device 300 does not have suitable applications to process the file type of the content 302 (‘mypkg.jarx’ application). The device 300 may further include a Universal Software Installation Framework (USIF) 308 for the installation of new software and applications. The application engine 306 requests the USIF 308 to arrange the suitable application to process the ‘mypkg.jarx’ application.

The device 300 further includes an ADM 310, which is similar to the ADM described in conjunction with FIGS. 1 and 2. In an embodiment, the ADM 310 may be integrated with the USIF 308. The USIF 308 interacts with the ADM 310 to arrange for the suitable applications to process the ‘mypkg.jarx’ application. The ADM 310 determines the dependencies for the installation of the ‘mypkg.jarx’ application.

The ADM 310 determines the dependencies for the installation of the mypkg.jarx application from an external source 312. Examples of the external source 312 may include, but are not limited to, the OVI server or the Horiozon server. In an example, the ADM 310 may determine that in order to install the ‘mypkg.jarx’ application, a jarx installer should be present at the device 300. It should be pointed out that for the installation of the jarx installer, any additional file may also be required to be present at the device 300 along with the jarx installer. Accordingly, the ADM 310 is configured to determine a first level of dependency of the ‘mypkg.jarx’ application (for example, the jarx installer), and also a second level of dependency (for example, dependency of the jarx installer). Accordingly, the ADM 310 is configured to determine the multi-level dependencies for the installation of the ‘mypkg.jarx’ application.

The ADM 310 may further download the jarx installer along with the dependencies of the jarx installer. Further, the ADM 310 provides the files corresponding to the dependencies to the USIF 308. The jarx installer is further provisioned by the USIF 308. The USIF 308 then notifies the application engine 306 of the jarx installer. In an embodiment, the application engine 306 passes the ‘mypkg.jarx’ application to the USIF 308 corresponding to the jarx installer. Further, the ‘mypkg.jarx’ application is then installed by the USIF 308 using the jarx installer.

In another example, the content 302 may be a document ‘mypage.xidf’. It is determined that the device 300 may not be able to access the document ‘mypage.xidf’. For example, the application engine 306 may not find the appropriate application to access the document ‘mypage.xidf’. The application engine 306 requests the USIF 308 to download an application for accessing the document ‘mypage.xidf’. The USIF 308 then interacts with the ADM 310. The ADM 310 interacts with the external server 312 to identify the list of applications that can open the document ‘mypage.xidf’. In an embodiment, there may be an ADM component present at the external server 312 that provides the list of applications that can open the document ‘mypage.xidf’.

In an embodiment, a user may be provided with a list of application packages to choose an application package that can be downloaded at the device 300. In one form, such list of application packages may also be provided with package details such as size, version, and the like. The user may select the application package, for example, an ABC Reader. Thereafter, the ABC reader may be downloaded by the ADM 310. Downloaded application package (the ABC reader) is installed by the USIF 308 at the device 300. The ABC reader may be installed at the device 300 using suitable installers, such as Native, Java, Python, and the like. The USIF 308 then notifies the application engine 306 of the ABC reader. The application engine 306 further accesses the document mypage.xidf using the ABC Reader.

In yet another embodiment, the present disclosure may also provide a device including various means for automatically provisioning content thereon. These means may be utilized for carrying out the method 100, or the functionalities of the device 200, as described above.

For example, the device may include means for receiving content to be processed at a device, means for automatically determining files required for processing the content if the content is unable to be processed at the device. The device may further include means for downloading the required files for processing the content from a source external to the device, and means for processing the content at the device using the required files. These means for automatically provisioning content at the device may be configured to perform the specified functions as described in flowchart of the methods 100. For the sake of brevity of the description, the functionalities of these means for automatically provisioning the content is not described again, as such functionalities are already described in conjunction with the flowchart of method 100, and the device 200.

Further, it should be understood that these means for automatically provisioning content in a device may be implemented in a hardware solution using electronic circuitries, or even though as computer software code, or their combination.

Furthermore, the various embodiments may take the form of a computer program product for automatically provisioning of content at a device, on a computer-readable storage medium having computer-readable program instructions (e.g., computer software) embodied in the computer-readable storage medium. Any suitable computer-readable storage medium (hereinafter ‘storage medium’) may be utilized including hard disks, CD-ROMs, RAMs, ROMs, Flash memories, optical storage devices, or magnetic storage devices.

The present disclosure is described above with reference to block diagrams and flowchart illustrations of methods and device embodying the present disclosure. It will be understood that each block of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to produce a machine, such that the set of instructions when executed on the computer or other programmable data processing apparatus create a means for implementing the functions specified in the flowchart block or blocks. Although other means for implementing the functions including various combinations of hardware, firmware and software as described herein may also be employed.

These computer program instructions may also be stored in a computer-readable medium that can cause a computer or other programmable data processing apparatus to function in a particular manner, such that the instructions stored in the computer-readable memory produce an article of manufacture including computer-readable instructions for implementing the function specified in the flowchart of the method 100. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart of the method 100.

The foregoing descriptions of specific embodiments of the have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. A method comprising:
receiving a content to be processed at a device;
downloading at least one file for processing the content from a source external to the device; and
processing the content at the device by using the at least one file.

2. The method of claim 1 further comprising checking presence of the at least one file for processing the content at the source external to the device.

3. The method of claim 1, further comprising, upon receiving the content:
downloading a latest version of an application dependency manager at the device, wherein the application dependency manager is configured to download the at least one file for processing the content.

4. The method of claim 3, wherein the application dependency manager is downloaded by a bootstrap application present in the content.

5. The method of claim 1, wherein the content is an application package.

6. The method of claim 5, wherein the at least one file for processing the application package comprise dependencies for installing the application package at the device.

7. The method of claim 6, wherein the dependencies comprise at least one of installers, run time applications, toolkits, libraries and frameworks.

8. The method of claim 1, wherein the content is a document.

9. The method of claim 8, wherein the at least one file for processing the document comprises an application package for accessing the document.

10. The method of claim 8, wherein downloading the at least one file for processing the document comprises:
determining a set of application packages, present at the source external to the device, for accessing the document;
providing an option of selecting an application package from the set of application packages; and
provisioning the application package at the device from the external source based on the selection.

11. The method of claim 10, further comprising:
installing the application package at the device; and
accessing the document at the device by using the application package.

12. The method of claim 1 further comprising, determining files required for processing the content.

13. A device comprising:
at least one processor; and
at least one memory comprising computer program code, the at least one memory and the computer program code configured to, with the at least one processor, cause the device at least to perform:
receiving a content to be processed at the device;
downloading at least one file for processing the content from a source external to the device; and
processing the content at the device by using the at least one file.

14. The device of claim 13, wherein the at least one memory and the computer program code configured to, with the at least one processor, cause the device at least to further perform:
checking presence of the at least one file for processing the content at the source external to the device.

15. The device of claim 13, wherein the at least one memory and the computer program code configured to, with the at least one processor, cause the device at least to further perform:
downloading a latest version of an application dependency manager at the device, wherein the application dependency manager is configured to download the at least one file for processing the content.

16. The device of claim 15, wherein the at least one memory and the computer program code further configured to, with the at least one processor, cause the device at least to further perform:
downloading the application dependency manager by a bootstrap application present in the content.

17. The device of claim 13, wherein the content is an application package.

18. The device of claim 17, wherein the at least one for processing the application package comprises dependencies for installing the application package at the device.

19. The device of claim 18, wherein the dependencies comprise at least one of installers, run time applications, toolkits, libraries and frameworks.

20. The device of claim 13, wherein the content is a document.

21. The device of claim 20, wherein the at least one file for processing the document comprises an application package for accessing the document.

22. The device of claim 20, wherein the at least one memory and the computer program code further configured to, with the at least one processor, cause the device at least to further perform:
determining a set of application packages, present at the source external to the device, for accessing the document;
providing an option of selecting an application package from the set of application packages; and
provisioning the application package at the device from the source based on the selection.

23. The device of claim 22, wherein the at least one memory and the computer program code further configured to, with the at least one processor, cause the device at least to further perform:
installing the application package at the device; and
accessing the document at the device by using the application package.

24. The device of claim 13, wherein the at least one memory and the computer program code further configured to, with the at least one processor, cause the device at least to further perform:
determining files required for processing the content.

25. A computer program product comprising at least one computer-readable storage medium, the computer-readable storage medium comprising a set of instructions configured to cause a device at least to perform:
receiving a content to be processed at the device;
downloading at least one file for processing the content from a source external to the device; and
processing the content at the device by using the at least one file.

26. A computer program product of claim 25, wherein set of instructions are further configured to cause a device at least to further perform: determining files required for processing the content.
